(19) United States
(12) Patent Application Publication
(10) Pub. No.: US 2009/0060700 A1
(43) Pub. Date: Mar. 5, 2009

(54) PALLET STORAGE

(76) Inventor: Allan Grainger, Merthyr Tydfil (GB)

Correspondence Address: KING & SCHICKLI, PLLC, 247 NORTH BROADWAY, LEXINGTON, KY, 40507, US

(21) Appl. No.: 12/203,990

(22) Filed: Sep. 4, 2008

Related U.S. Application Data
(60) Provisional application No. 60/969,746, filed on Sep. 4, 2007.

(51) Int. Cl. B65G 57/00

(52) U.S. Cl. 414/788.9

(57) ABSTRACT

A storage system includes a pallet (100) having first and second pallet side formations (110) projecting from opposing outer side surfaces and at least one pallet end formation (114) located in or on a rear end surface of the pallet. The system also includes a pallet support apparatus (200) having first and second support apparatus side formations (210) projecting from opposing inner side surfaces and at least one support apparatus end formation (214) located in or on a rear end surface of the support apparatus. In use, when the pallet is loaded onto the support apparatus, the first and second pallet side formations engage with the first and second support apparatus side formations, respectively, and the at least one pallet end formation engages with the at least one support apparatus end formation, thereby preventing or reducing relative vertical movement of the pallet and the support apparatus.

The present application claims priority from U.S. provisional patent application Ser. No. 60/969,746 filed on Sep. 4, 2007.

### FIELD OF THE INVENTION

The present invention relates to pallet storage.

### BACKGROUND TO THE INVENTION

When items such as pallets are transported, they cannot necessarily rely on their own weight and that of the load that they carry to keep them fixed. They have to be constrained in some way. Traditionally, they have been lashed down by ropes, wires or chains, but those take time to set up and undo, and they are wasteful of space since there has to be room around the pallet. Also, loaded pallets cannot be directly stacked one on another.

It is therefore desirable to close pack pallets and the like in racks, but just placing them on shelves does not solve the problem. They have to be held down in transit, and it is desirable to keep the items secure in a compact arrangement, and yet easy to load and unload.

Restraining items such as pallets can be even more problematic when the racks are onboard moving aircraft and are subjected to considerable forces, e.g. 3-5 G. Usually, a large number of ropes, etc are required to tie the items in this situation, but this takes up a considerable amount of time and means that removing the pallets is also an awkward and time-consuming process. This is clearly disadvantageous when the contents need to be unloaded quickly in an emergency situation. Some parts of racks (e.g. especially wheels on which the pallets can roll out) that are not specially constructed to withstand the high forces can also bend, which can cause the pallet or the like to become stuck in the rack.

It can also be difficult to correctly load and unload items such as pallets from a rack that is on an uneven (or moving) surface. The frame of the rack may slope and so the rails upon which the items rest can be mis-aligned vertically. In existing racks where a pallet is slotted into a channel having lower and upper flanges, it can be difficult or impossible to correctly position the pallet into the channel using a fork lift truck or the like which holds the pallet substantially horizontally. The present inventor has found that relative movement between a pallet and the frame is particularly acute at the front and/or rear ends.

### SUMMARY OF THE INVENTION

Embodiments of the present invention are intended to address at least some of the problems outlined above.

According to a first aspect of the present invention there is provided a pallet storage system including:

a pallet including:
a first pallet side formation projecting from an outer side surface of the pallet, the first side formation being fixed at or towards a front end of the pallet;
a second pallet side formation projecting from an outer side surface of the pallet opposite the side surface of the first side formation, the second side formation being fixed at or towards the front end of the pallet;
at least one pallet end formation located in or on a rear end surface of the pallet; and

a pallet support apparatus including:
a first support apparatus side formation projecting from an inner side surface of the support apparatus, the first side formation being fixed at or towards a front end of the support apparatus;
a second support apparatus side formation projecting from an inner side surface of the support apparatus opposite the side surface of the first support apparatus side formation, the second side support apparatus formation being fixed at or towards the front end of the support apparatus, and
at least one support apparatus end formation located in or on a

rear end surface of the support apparatus;

where, in use when the pallet is loaded onto the support apparatus, the first and second pallet side formations engage with the first and second support apparatus side formations, respectively, and the at least one pallet end formation engages with the at least one support apparatus end formation, thereby preventing or reducing relative vertical movement of the pallet and the support apparatus.

The first and/or second pallet side formation may comprise a first substantially straight portion having a second substantially straight portion extending at an angle from one end of the first substantially straight portion. The first straight portion of a said pallet side formation may be substantially parallel with a side wall of the pallet. The second straight portion of a said pallet side formation may extend downwards and towards the rear end of the pallet from the first straight portion.

The first and/or second support apparatus side formation may comprise a first substantially straight portion having a second substantially straight portion extending at an angle from one end of the first substantially straight portion. The first straight portion of a said support apparatus side formation may be substantially parallel with a side wall of the support apparatus. The second straight portion of a said support apparatus side formation may extend downwards and towards the rear end of the support member from the first straight portion.

An upper surface of a said pallet side formation may engage with a lower surface of a said support apparatus side formation.

A said support apparatus side formation may include a dampening, e.g. plastic, material on at least part of its lower surface.

The support apparatus may further include at least one guiding member fixed to an inner side surface of the support device. In some embodiments a front said guiding member is fixed at or adjacent a front end of the support apparatus and a rear said guiding member is fixed at or adjacent a rear end of the support apparatus. The front guiding member may be located below a corresponding said support apparatus side formation such that, in use, a corresponding said pallet side formation fits between the front guiding member and the corresponding pallet side formation. The guiding member may be formed of a resilient material. In some embodiments the guiding member comprises a strip of resilient material that curves inwardly from the inner side surface of the support device.

The at least one pallet rear formation may include a male member and the at least one support apparatus rear formation includes a female member (or vice versa in alternative embodiments).

A said inner side surface of the support apparatus and/or a base of the support apparatus may include a strip of low-friction material to assist with loading the pallet into the support apparatus.

The support apparatus may include at least one gate that, in use, blocks a front end of the support apparatus.

The system may further include a pinch bar for assisting with releasing a said pallet from the support apparatus.

According to another aspect of the present invention there is provided a pallet substantially as described herein.

According to yet another aspect of the present invention there is provided a pallet support apparatus substantially as described herein.

Whilst the invention has been described above, it extends to any inventive combination of features set out above or in the following description. Although illustrative embodiments of the invention are described in detail herein with reference to the accompanying drawings, it is to be understood that the invention is not limited to these precise embodiments. As such, many modifications and variations will be apparent to practitioners skilled in the art. Furthermore, it is contemplated that a particular feature described either individually or as part of an embodiment can be combined with other individually described features, or parts of other embodiments, even if the other features and embodiments make no mention of the particular feature. Thus, the invention extends to such specific combinations not already described.

### BRIEF DESCRIPTION OF THE DRAWINGS

The invention may be performed in various ways, and, by way of example only, embodiments thereof will now be described, reference being made to the accompanying drawings in which:

FIGS. 1A to 1D are plan, front, side and rear, respectively, views of an example of a pallet;

FIGS. 2A to 2C are plan, front and side (from arrow A in FIG. 2A), respectively, views of a pallet support apparatus;

FIG. 3 details a formation fixed to an inner side surface of the pallet support apparatus;

FIGS. 4A and 4B are plan and front, respectively, views of the pallet fitted within the support apparatus;

FIG. 5 details engagement between components of the pallet and the support apparatus, and

FIGS. 6A and 6B are schematic side views showing an example of how the pallet can be released from the support apparatus.

### DETAILED DESCRIPTION OF THE DRAWINGS

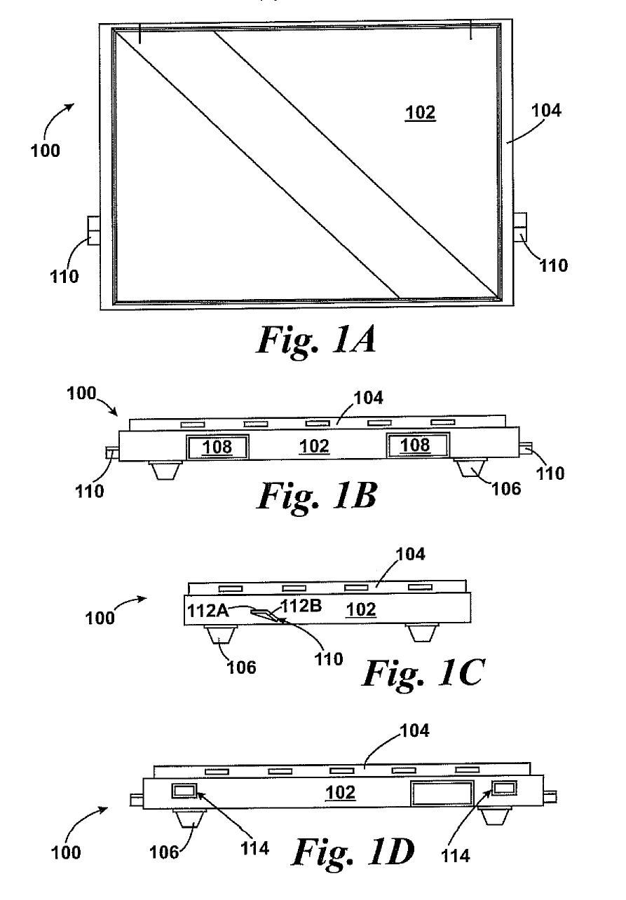

Referring to FIGS. 1A to 1D, an example of a pallet 100 is shown. The pallet comprises a rectangular base 102 that can be formed of any suitable material(s), such as wood or metal. The base may be a single piece or may comprise several members fixed together using any appropriate means. A side wall 104 may run around at least part of the perimeter of the upper surface of the pallet base 102. The side wall can be formed of any suitable material(s), e.g. metal, and can include apertures or the like for allowing straps, ropes, etc, to secure/tie goods that have been loaded onto the pallet. It will be appreciated that the pallet illustrated in the Figures is exemplary only and several variations to its shape, construction materials and dimensions are possible. The pallet can vary in size, typically having a width of around 900 mm to 2000 mm+ and a (front to rear end) length of around 900 mm to 1500 mm+.

In some embodiments, a set of feet 106 may be fixed to the lower surface of the pallet 100. The front end (the end which, in use, is located at an access end of a support apparatus) can include pockets 108 for receiving the forks of a fork lift truck. The features described so far as substantially conventional and can be found in many existing pallets.

A side projection 110 is fixed, e.g. by welding, to an outer side surface of each side wall of the pallet 100. The two side formations are substantially identical and are fixed at corresponding positions on their respective side walls. As can be seen in FIG. 1C, each side formation comprises a first straight portion 112A (which may be formed of any suitable material such as steel). A second straight portion 112B extends from the end of the first straight portion that is nearest the rear end of the pallet. The second straight portion 112B extends rearwardly and downwards at an angle of around 300 to the horizontal. The front end of the first straight portion 112A is spaced apart from the front end of the pallet, although it could be located at the front end. The length of the first member can be around 38 mm (1.5″) to 63.5 mm (2.5″) and it can have a width of around 38 mm (1.5″). It will be understood that the side formation shown in the Figures is exemplary only and variations are possible. For instance, the side formations could comprise two or more separate members, or have the shape of an angled bracket (<) or the like. The side formations will normally be located on an outer side surface of the base 102 at any point between the front end and about halfway along the length of the pallet. In use, as will be described below, the side formations 110 can therefore assist with preventing/reducing vertical motion of the pallet relative to a support apparatus, in particular relative movement of the front end of the pallet.

As can be seen in the rear view of FIG. 1D, the base of the pallet further includes a pair of rectangular blind bores 114.

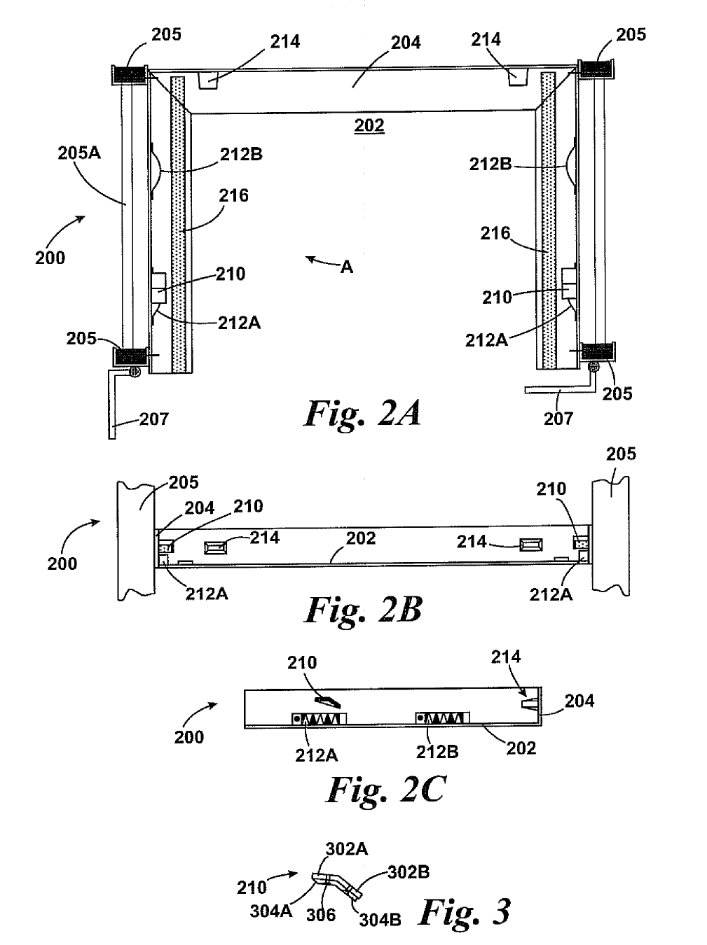

Turning to FIGS. 2A to 2D, an example of apparatus 200 that is intended to support the pallet 100 is shown. The support apparatus comprises a rectangular base 202 that can be formed of any suitable material(s), e.g. steel. Side/rear walls 204 extend upwardly from the side and rear edges of the base 202. It will be appreciated that in practice the shape and dimensions of the support apparatus will normally be chosen to correspond with those of the pallet that it is intended to support. In cases where the pallet to be supported includes feet then suitable elongate slits (not shown) may be provided in the base 202 to allow the feet to slide through the base. The support apparatus may be directly fixed to a set of uprights 205, e.g. one at each corner, or (e.g. by means of bolts) to an outer frame 205A that is fixed to the uprights. One or more support devices may be mounted in this way so that the combination effectively forms a rack for storing one or more pallets.

The front end of the support apparatus may include at least one gate 207.

In the example there are a pair of gates 207, each gate being pivotally connected to the front of one side of the support apparatus/uprights. Each gate can extend partially across the open width of the support apparatus when in its closed position (e.g. the right hand gate in FIG. 2A) in order to provide further security for a pallet that has been loaded into the support apparatus. It will be understood that alternative means for secure a loaded pallet in the support apparatus may be provided, e.g. bolts or locks.

The inner side surfaces of the support apparatus each include a side formation 210. Generally, the location and configuration of each of the support apparatus side formations will be selected to correspond with those of the side formations 110 of the pallet. As detailed in FIG. 3, each side formation in the example includes a first straight portion 302A from which a second straight portion 302B extends downwardly and towards the rear end of the support apparatus, at an angle corresponding to that of the second portion 112B of the pallet side formation 110. The portions 302 can be formed of rigid material such as steel. The lower surfaces of the straight portions 302A, 302B are formed by corresponding straight portions 304A, 304B respectively, made of a material such as plastic to avoid direct metal to metal contact between the straight portion 302 and 112, hence assisting with dampening vibration when the pallet/support apparatus combination is transported. The lower portions 304 may be fixed to the upper portions by means of screws 306 or the like. The pallet side formations 110 can (also or instead of support apparatus parts 210) be formed in a similar manner (with the plastic portion being on top). The straight portions 304A, 304B may be shorter than the corresponding straight portions of pallet formations 110. Again, it will be understood that the dimensions and design of the side formations can be varied, typically to correspond with those of the pallet side formations.

The inner side walls of the support apparatus further include a set of guiding members. In the example, each side surface includes two guiding members, one guiding member 212A being located at a point between the front end and about halfway along the length of the side wall. The other guiding member 212B is located at a point between the rear end and about halfway along the length of the side wall. The guiding member 212B on the front half of the side wall is located beneath the side formation 210. In the example, each guiding member 210 comprises a strip of spring steel that has been bent with the curved portion of the strip extending towards the interior of the support apparatus, with at least one end of the strip being fixed to the side wall, e.g. by means of a nut/bolt arrangement. However, it will be appreciated that the design, number and location of the guiding members can be varied, e.g. they may comprise one or more rounded plastic projections.

The rear wall of the support apparatus includes at least one formation 214. In general, the number, location and design of the at least one formation 214 will be chosen to correspond with the rear formation(s) on the pallet 100. Thus, in the example there are two support apparatus rear formations 214, each of which comprises a projection that is designed to fit into the bores 114 on the pallet in use. However, it will be understood that variations are possible, e.g. the rear wall of the support apparatus may comprise at least one bore/aperture and at least one corresponding projection can be located on the rear wall of the pallet.

The inner side surfaces of the side walls of the support apparatus each further include a strip 216 (best seen in FIG. 2A) of low friction material, e.g. high density oil impregnated plastic. Alternatively or additionally, the strips could be located on the upper surface of the base 202. It will be understood that the strip 216 is exemplary only and variations are possible, e.g. it could be intermittent instead of continuous.

Turning to FIGS. 4A and 4B, the pallet 100 is shown loaded into the support apparatus 200 (some parts are shown as being transparent for ease of understanding). In use, the gates 207 are opened and the pallet 100 is inserted (rear end first, typically using a fork lift truck) into the support apparatus between its side walls 204, with the lower surface of the base 102 of the pallet being located above/sliding along the upper surface of the base 202 of the support apparatus. As the pallet is moved further inside the support apparatus, the sides of the pallet will contact the front guiding members 212A. The flexible/resilient nature of the guiding members means that they assist with keeping the side walls of the pallet aligned with the side walls of the support apparatus, thereby reducing the chances of misalignment. Similarly, when the pallet is further inserted into the support apparatus, its side surfaces will contact the rear guiding members 212B. Insertion of the pallet continues until its rear wall contacts the rear wall of the support apparatus and/or the pallet side formations 110 contact the support apparatus side formations 210.

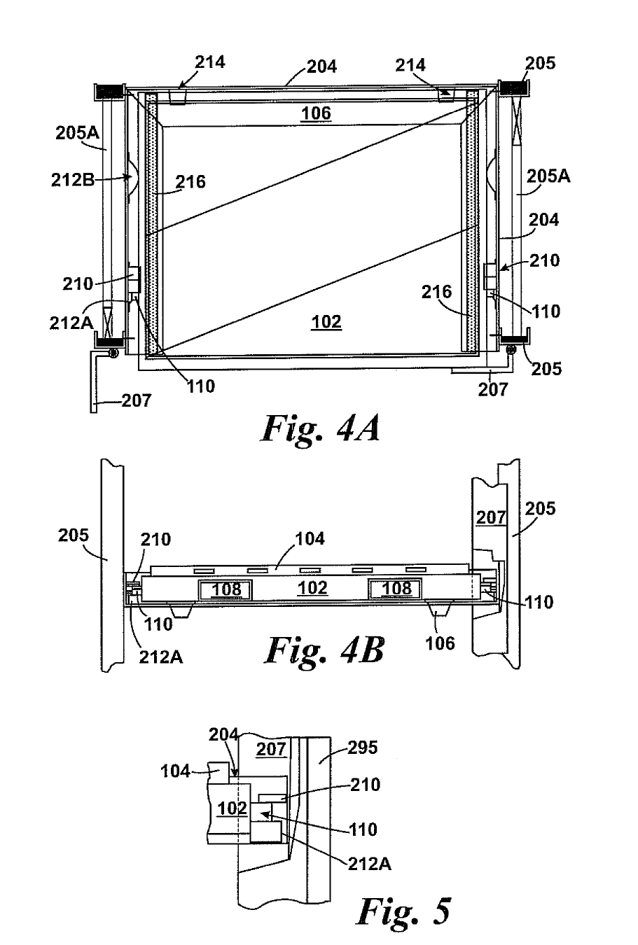

The rear formations 114 of the pallet engage with the rear formations 214 of the support apparatus, thereby assisting with securing the pallet within the support apparatus 200 and preventing relative movement in the vertical direction, particularly at the rear end of the pallet/frame. Contact between the pallet side formations 110 and support apparatus side formations 210 also helps prevent movement in a rearward direction and relative movement of the pallet and frame in a vertical direction (especially at the front end of the pallet/frame). FIG. 5 further details the engagement of these components. As can be seen there is a gap (typically up to around 76 mm (3″)) between the outer side surface of the base 102 of the pallet and the adjacent side surface of the support apparatus side formation 210, and also a gap between the side of the pallet side formation 110 and the side wall 204 of the support apparatus.

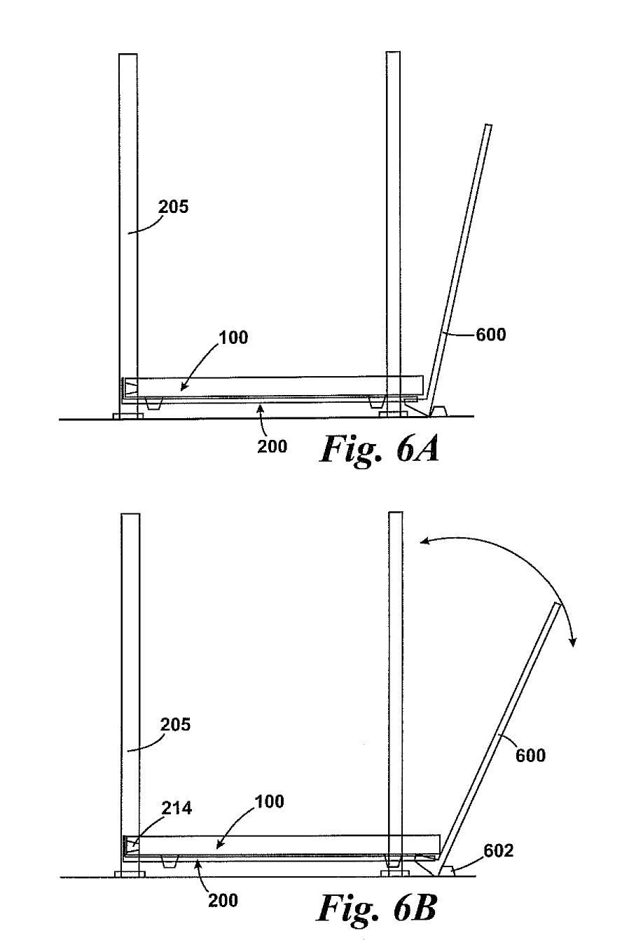

The pallet may be removed from the support apparatus using a fork lift truck. However, it has been found that on some occasions the security provided by the fixing formations of the pallet/support apparatus is so effective that a “pinch” bar (a lever with a pointed projection that serves as a fulcrum) may be needed to break contact between the pallet/support apparatus rear formations. FIGS. 6A and 6B show an example of the use of such a pinch bar 600 to release a pallet 100 from a support apparatus 200 (some parts are shown as being transparent for clarity). The pinch bar may be provided with/stored in a container/pallet/storage apparatus, possibly linked to it using a chain or the like to prevent the pinch bar going missing. A floor-mounted stop/bar 602 (e.g. located on the floor of an outer container) may be used in conjunction with the pinch bar.

I claim:

1. A pallet storage system including:
a pallet (100) including:
a first pallet side formation (110) projecting from an outer side surface of the pallet, the first side formation being fixed at or towards a front end of the pallet;
a second pallet side formation (110) projecting from an outer side surface of the pallet opposite the side surface of the first side formation, the second side formation being fixed at or towards the front end of the pallet;
at least one pallet end formation (114) located in or on a rear end surface of the pallet; and
a pallet support apparatus (200) including:
a first support apparatus side formation (210) projecting from an inner side surface of the support apparatus, the first side formation being fixed at or towards a front end of the support apparatus;
a second support apparatus side formation (210) projecting from an inner side surface of the support apparatus opposite the side surface of the first support apparatus side formation, the second side support apparatus formation being fixed at or towards the front end of the support apparatus, and
at least one support apparatus end formation (214) located in or on a rear end surface of the support apparatus;
where, in use when the pallet is loaded onto the support apparatus, the first and second pallet side formations engage with the first and second support apparatus side formations, respectively, and the at least one pallet end formation engages with the at least one support apparatus end formation, thereby preventing or reducing relative vertical movement of the pallet and the support apparatus.

2. A system according to claim 1, wherein the first and/or second pallet side formation (210) comprises a first substantially straight portion (112A) having a second substantially straight portion (112B) extending at an angle from one end of the first substantially straight portion.

3. A system according to claim 2, wherein the first straight portion (302A, 304A) of a said pallet side formation (110) is substantially parallel with a side wall (204) of the pallet (100).

4. A system according to claim 3, wherein the second straight portion (112B) of a said pallet side formation (110) extends downwards and towards the rear end of the pallet (100) from the first straight portion (112A).

5. A system according to claim 1, wherein the first and/or second support apparatus side formation (210) comprises a first substantially straight portion (302A) having a second substantially straight portion (302B) extending at an angle from one end of the first substantially straight portion.

6. A system according to claim 5, wherein the first straight portion (302A) of a said support apparatus side formation (210) is substantially parallel with a side wall (204) of the support apparatus (200).

7. A system according to claim 5, wherein the second straight portion (302B) of a said support apparatus side formation (210) extends downwards and towards the rear end of the support apparatus (200) from the first straight portion (302A).

8. A system according to claim 1, wherein an upper surface of a said pallet side formation (110) engages with a lower surface of a said support apparatus side formation (210).

9. A system according to claim 1, wherein a said support apparatus side formation (210) include a dampening, e.g. plastic, material (304A, 304B) on at least part of its lower surface.

10. A system according to claim 1, wherein the support apparatus (200) further includes at least one guiding member (212) fixed to an inner side surface of the support apparatus.

11. A system according to claim 10, including a front said guiding member (212A) fixed at or adjacent a front end of the support apparatus (200) and a rear said guiding member (212B) fixed at or adjacent a rear end of the support apparatus.

12. A system according to claim 11, wherein the front guiding member (212A) is located below a corresponding said support apparatus side formation (210) such that, in use, a corresponding said pallet side formation (110) fits between the front guiding member and the corresponding pallet side formation.

13. A system according to any claim 11, wherein the guiding member (212) comprises a, strip (216) of resilient material that curves inwardly from an inner side surface of the support device (200).

14. A system according to claim 1, wherein the at least one pallet end formation (114) includes a male or female member and the at least one support apparatus end formation (214) includes a female or male member, respectively.

15. A system according to claim 1, wherein the support apparatus (200) includes at least one gate (207) that, in use, blocks a front end of the support apparatus.

16. A pallet (100) including:
a first pallet side formation (110) projecting from an outer side surface of the pallet, the first side formation being fixed at or towards a front end of the pallet;
a second pallet side formation (110) projecting from an outer side surface of the pallet opposite the side surface of the first side formation, the second side formation being fixed at or towards the front end of the pallet;
at least one pallet end formation (114) located in or on a rear end surface of the pallet; and
where, in use when the pallet is loaded onto a support apparatus (200), the first and second pallet side formations engage with respective first and second side formations on the support apparatus and the at least one pallet end formation engages with corresponding at least one end formation on the support apparatus, thereby preventing or reducing relative vertical movement of the pallet and the support apparatus.

17. A pallet support apparatus (200) including:
a first support apparatus side formation (210) projecting from an inner side surface of the support apparatus, the first side formation being fixed at or towards a front end of the support apparatus;
a second support apparatus side formation (210) projecting from an inner side surface of the support apparatus opposite the side surface of the first support apparatus side formation, the second side support apparatus formation being fixed at or towards the front end of the support apparatus, and
at least one support apparatus end formation located in or on a rear end surface of the support apparatus;
where, in use when a pallet (100) is loaded onto the support apparatus, first and second side formations (110) on the pallet engage with the first and second support apparatus side formations, respectively, and the at least one end formation (114) on the pallet engages with the at least one support apparatus end formation, thereby preventing or reducing relative vertical movement of the pallet and the support apparatus.
